(19) United States
(12) Patent Application Publication
(10) Pub. No.: US 2008/0164278 A1
(43) Pub. Date: Jul. 10, 2008

(54) Fastening Device

(76) Inventor: Martin Myerscough, Suffolk (GB)

Correspondence Address: Vedder Price Kaufman & Kammholz, 222 N. Lasalle Street, Chicago, IL, 60601, US

(21) Appl. No.: 10/541,505

(22) PCT Filed: Jan. 7, 2004
(86) PCT No.: PCT/GB2004/000032

§ 371 Date: Jan. 30, 2008

(30) Foreign Application Priority Data
Jan. 10, 2003 (GB) 0300628.5

(51) Int. Cl. B65H 5/28; B42F 3/00; G09F 1/00; B41L 43/12

(52) U.S. Cl. 221/69; 221/74; 24/67.3; 40/124.01; 270/37

(57) ABSTRACT

A fastening system that enables a tab to be positioned around items to be joined, and a fastener to be passed through the tab and the items to be joined to fasten these. The invention relates to a fastening device for effecting the system, a magazine for storing and dispensing tabs and to the tabs.

It is well known to join a number of items, such as two or more sheets of paper, together using a staple. A staple is usually in the form of a generally U-shaped piece of wire. The legs of the staple are driven through the items to be joined, and are then deformed on the rear of the items being joined to hold these together as a unitary item. The free ends of the legs may be pointed to assist with the penetration of the items to be joined.

Staples are usually provided as a stick or strip of U-shaped staples joined together by a frangible bridge. To staple items together, a stick or strip of staples are provided in a stapling machine or stapler. The stapler includes a means for removing one of the staples from the stick or strip of staples, driving the legs of the removed staple through the items to be joined, and deforming the legs of the staple that have passed through the items to be joined.

One disadvantage in joining items together with a staple is that it can be difficult to remove the staple to separate the items, especially without causing damage to the items. To remove a staple, it is necessary to bend the deformed legs of the staple straight, and then pull the staple from the items that were joined by the staple. However, it can be difficult to straighten the legs of the staple. Even if the legs are straightened, it can be difficult to grasp the staple to pull this from the items that were joined by the staple. Especially if the legs of the staple are not straightened, the removal of the staple is liable to damage the items held by the staple, for example by tearing these.

There are a number of tools that have been developed to assist with the removal of staples. However, these tools are not always available when it is necessary to remove a staple. Further, these tools are not always able to cleanly remove a staple without damage to the items held by the staple.

GB-A-2252748 discloses an adjunct for use with a staple. The adjunct is formed as a moulded one-piece construction comprising a first panel and a second panel linked by a live hinge. In use, the adjunct is applied to a plurality of paper sheets by folding it along the hinge such that the plurality of sheets is sandwiched between the first and second panels. Using a conventional stapler, a staple is then driven through the adjunct and the plurality of sheets simultaneously. To remove the staple, turn-up-tabs formed on each of the first and second panels of the adjunct are pulled away from the paper to open the adjunct. This causes the legs of the staple to unfold and straighten. The base of the staple is connected to the adjunct, and so continued pulling of the adjunct removes the staple from the sheets of paper, allowing these to be separated. In this way, it is possible to easily remove a staple without requiring additional tools, and without causing unnecessary damage to the sheets of paper held by the staple. However, it is difficult and time consuming to arranging the adjunct around the sheets of paper and maintaining this arrangement whilst driving a staple through the adjunct and sheets. Accordingly, the staple adjunct shown in this prior art has not achieved commercial success.

GB 2036226 teaches a staple fastener comprising an upper element having a staple integrally formed with a cross member and a lower, receiving element. In use, the staple and cross member are arranged on one side of a number of sheets and the receiving member is arranged on the opposite side of the sheets. This system therefore does not involve the separate handling of a staple and a tab member, as is the case in GB 2252748. However, the document teaches the use of two separate members, which must be aligned precisely so that the prongs of the staple are received by the receiving member. The staple fastener has the further disadvantage that neither of the elements of the fastener are simple and cheap to produce. The document teaches that the upper element can be formed from a thermoplastics material such that a traditional staple can be inserted therein before complete hardening of the plastics material. The lower, receiving element is formed with at least two layers, an upper layer which is soft and a lower layer which is harder. Accordingly, the fastener described in GB 2036226 suffers from the problem that the high costs involved in producing the fasteners renders their use commercially impractical.

Other types of fastener are known, for example stitches, bifurcated fasteners and the like.

According to a first aspect of the present invention, a fastening device includes a magazine holding at least one tab, the tab having a first portion and a second portion, the first and second portions being joined along a hinge such that the free ends of the first and second portions are biased away from each other, the first portion having a different size and/or shape to the second portion, the magazine including an opening through which the tab is dispensed, the opening including a retainer for retaining the second portion of the tab from moving in a first direction whilst allowing the first portion of the tab to move in the first direction, the tab being removable from the magazine in a second direction generally perpendicular to the first direction to a fastening position, and a fastening mechanism for driving joining the tab and items to be joined.

In use, the first portion of the tab passes through the opening of the magazine in a first direction whilst the second portion of the tab is retained by the retainer. The tab therefore has an open configuration. A number of items, such as a number of sheets of paper to be joined together, is provided to the fastening device, passing between the first and second portions of the tab. The continued movement of the items to be joined in a second direction acts to push the tab out of the magazine in the second direction to a fastening position. In this position, the fastening device positions a fastener through the items to be joined that are sandwiched by the tab. The items and tab are then removed from the fastening device. In this way, a portion of the tab is automatically positioned on either side of the items to be joined as the fastener is provided through the items to be joined in such a way that the fastener also passes through the portions of the tab.

In one example, the fastener is a staple or a similar component. In this case, the staple is driven through the tab and the items to be joined. The legs of the staple driven through the tab and items to be joined may be deformed to join the items. In this case, when the staple is to be removed, the first and second portions of the tab may be pulled apart, straightening the legs of the staple and drawing the staple through the joined items without requiring additional tools or without causing significant damage to the items joined.

In an alternative example, the fastener may be in the form of a stitch. In this case, a thread may be driven through the tab and the items to be joined a number of times. In this case, when the items are to be separated, the first and second portions of the tab may be pulled apart, breaking the thread.

The arrangement of a tab around the items to be joined and the application of a fastener to fix the tab and the items together can be achieved in a single step since the tab is simply “collected” by the sheets as the sheets move towards the fastening position. The procedure, and therefore the time taken, to fasten a tab and the items together in this way is essentially the same as that when tab is not used. This makes the dispensing of tabs in this way very cheap and commercially effective.

In a preferred embodiment of this invention, a mechanism is provided for selectively preventing the first portion of the tab from passing though the opening of the magazine. In this way, when a number of items to be joined are moved into the fastening position, the items do not pass between the first and second portions of a tab, and therefore do not engage and move a tab into the fastening position. In this way, the items can be fastened in a conventional manner, without using a tab. This is advantageous where the additional cost or convenience of a tab in the joined article is not required. This may be achieved by mechanical means such as a manually actuated sliding member or an electronic push button to close the first opening in the magazine. Alternatively or additionally, the magazine may be removed from the fastening device when a tab is not required.

The magazine may be retained in position by a suitable friction fit with the fastening device, or by a physical lock or latch, such as a detent.

According to a second aspect of the present invention, there is provided a magazine suitable for use in a fastening device such as that according to the first aspect of the present invention. The magazine is arranged to hold at least one tab having a first portion and a second portion, the first and second portions being joined along a hinge such that the free ends of the first and second portions are biased away from each other, the first portion having a different size and/or shape to the second portion. The magazine includes an opening through which the tab is dispensed, the opening including a retainer for retaining the second portion of the tab from moving in a first direction whilst allowing the first portion of the tab to move in the first direction, the tab being removable from the magazine in a second direction generally perpendicular to the first direction.

The retainer may be in the form of one or more projections or lips that extend into the opening of the magazine for retaining the second portion of the tab. The projection or lip is advantageously arranged in a position such that, when the first and second portions of the tab are adjacent each other, the projection extends over an area of the second portion of the tab not covered by the first portion. The retainer may be a reduced width opening part of a keyway slot.

Preferably, the tab members contained in the magazine are biased towards the opening of the magazine. In one example, the tab members may be biased though gravity. However, it is preferred that the magazine includes a resilient biasing means, such as a spring, to bias the tab members towards the opening of the magazine. This ensures that, to the extent that at least one tab member is contained in the magazine, a constant feed of tab members is achieved at the first opening. Further, this prevents the tab members from becoming loose and disorganised within the magazine. The spring is advantageously a coil spring which takes up little space in the magazine, or may be a simple compression spring.

The magazine may be formed from a plastic or metal material so that it is tough and hard wearing and suitable to be retained and refilled. In one example, the magazine has an openable or removable side through which the tabs may be inserted. The magazine may be disposable. In this case, the magazine may contain a predetermined number of tabs, such that, when these tabs have been used, the magazine is disposed of. In this case, the number of tabs contained in the magazine may correspond to the number of fasteners supplied to the fastening device. In this way, the tabs will run out at the same time as the fasteners.

The magazine should be removable from the stapler. This is advantageous as it allows the stapler to be used as a conventional stapler without the use of tabs when the magazine is removed. Also this allows the magazine, and therefore the tabs, to be changed easily.

The magazine advantageously includes an internal cross-section having a shape similar to the shape of the tabs to be dispensed. This will assist the loading and alignment of the tabs.

The magazine is advantageously formed of a transparent material, allowing a user to see how many tabs remain in the magazine. According to a third aspect of the present invention, there is provided a tab for use with a fastener device such as that in accordance with a first aspect of the present invention, or for use in a magazine according to a second aspect of the present invention. The tab includes a first portion and a second portion, the first and second portions being joined along a hinge such that the free ends of the first and second portions are biased away from each other, the first portion having a different size and/or shape to the second portion such that the second portion of the tab can be retained from moving in a first direction whilst allowing the second portion of the tab to move in the first direction, the tab being removable from a magazine in a second direction generally perpendicular to the first direction.

In one example, the first portion of the tab is shorter than the second portion of the tab. In this way, the retainer may engage the free end of the second portion of the tab, whilst not retaining the free end of the first portion of the tab. In an alternative example, the first portion of the tab has a smaller width than the second portion of the tab. In this way, the retainer may engage the side parts of the second portion of the tab, whilst not engaging the first portion. In this case, the second portion may include side parts that extend beyond the sides of the first portion. Where the tabs are formed with the first and second portions having a uniform width, as this allows the tabs to be cut from a sheet of material in a simple manner with minimum wastage. Where the tabs have a different width at different points along the length, the tabs need to be pressed from a sheet of material, moulded, or cut in a number of different directions. Also, where the tabs have a different width along their length, a number of tabs arranged on a sheet of material may not tessellate, and therefore this will lead to a waste of material when the tabs are cut from the sheet.

An advantage of providing the portions of the tab with different widths rather than different lengths is that the retained portion of the tab can be supported at a desired point along its length. Where the retained portion of the tab is retained by virtue of a longer length, it can only be supported at its free end, and so the hinged end will not be supported. This may be disadvantageous in some cases.

The tabs may have an attractive shape for presentational purposes. In this case, the magazine may include some features complimentary to the shape of the tabs to hold these in alignment.

The hinge of the tab is advantageously merely a fold between the first and second portions of the tab.

The tab is preferably formed from a plastics material, and more preferably from polypropylene. A tab formed from a plastics material has suitable resiliency along the hinge or fold joining the first and second portions, to ensure that the first and second portions of the tab are biased away from each other. Additionally, where it is desired to remove a staple holding a tab and a plurality of sheets together, a tab formed from a plastics material is strong enough that the portions thereof may be gripped and pulled away from the sheets of material causing the legs of the staple to open, thus releasing the sheets. As an alternative, the tab may be formed from a cardboard, stiff paper or fabric material. The tabs may be stamped out from a sheet of material, however it is preferred that the tabs are cut from a sheet of material. However, this may depend on the shape of the tab. Forming the tab members in this way allows a large quantity to be produced very quickly and cheaply. The tab preferably has a thickness of between about 0.1 mm and 0.75 mm, and preferably of about 0.25 mm. The thickness of the tab can be varied depending on their intended use. For example, a tab for heavy duty staple machines may be thicker than those for desk-top staplers that generally only staple a few sheets of thin paper.

Whilst the tabs may be moulded, rather than being cut or stamped, this may be too expensive, and may result in the tabs being too thick.

The tabs may advantageously be formed in a continuous strip, which is then folded into a concertina, before one end of the concertina is cut or otherwise removed. This will have the effect of separating the tabs.

In one example, a number of tab members are releasably fastened together so that they may be handled conveniently as a single unit. Where tabs are provided separately from the magazine, the fastening means may be maintained, removed or broken when the tab members are placed in the magazine.

Optionally, the tabs may be provided with printed matter so as to form labels. This printing may include instructions for their use, or other information such as the name of the company providing the items that are joined together using the tab. The tabs may be provided in different colours, and in this case the different colours may be used to signify different types of document.

According to a fourth aspect of the present invention, there is provided a method of joining items using the tabs of the third aspect of the present invention, which may be provided in a magazine according to the second aspect of the invention, for example being used in a fastening device according to the first aspect of the present invention. A method of fastening according to the fourth aspect of the present invention includes providing a tab having a first portion and a second portion, the first and second portions being joined along a hinge such that the free ends of the first and second portions are biased away from each other, the first portion having a different size and/or shape to the second portion, restraining second portion of the tab from moving in a first direction whilst allowing the first portion of the tab to move in the first direction, providing a number of items to be staples between the free ends of the first and second portions of the tab, and moving the items in a second direction generally perpendicular to the first direction to abut against the join between the first and second portions of the tab, and continuing the movement of the items to be joined to remove the tab in a second direction generally perpendicular to the first direction, and passing a fastener through the first and second portions of the tab sandwiching the items to be joined.

Elements of different aspects of the present invention may advantageously be combined.

The present invention will be described, by way of example with reference to the accompanying drawings, in which:

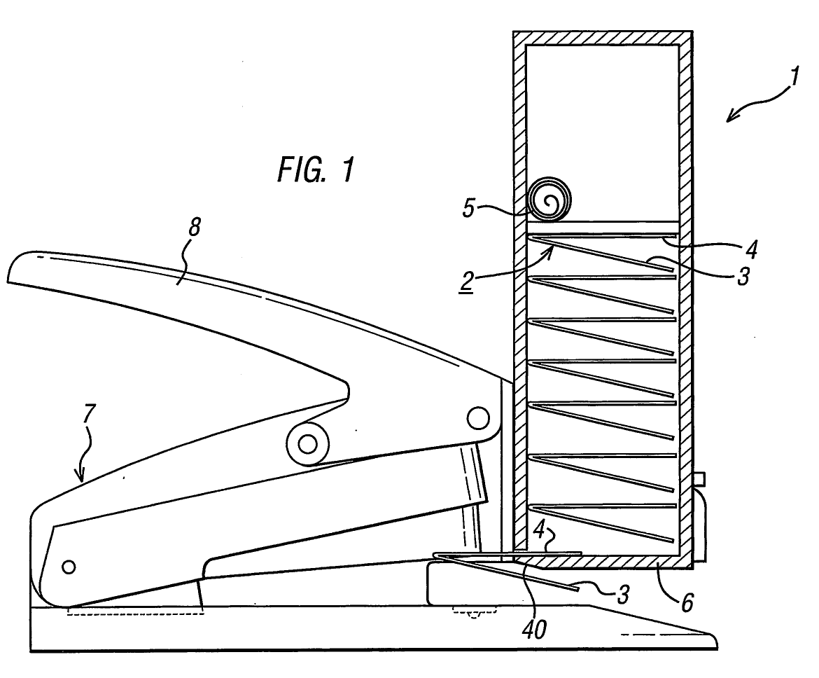

FIG. 1 shows a partial sectional view of a stapler in accordance with one aspect of the present invention;

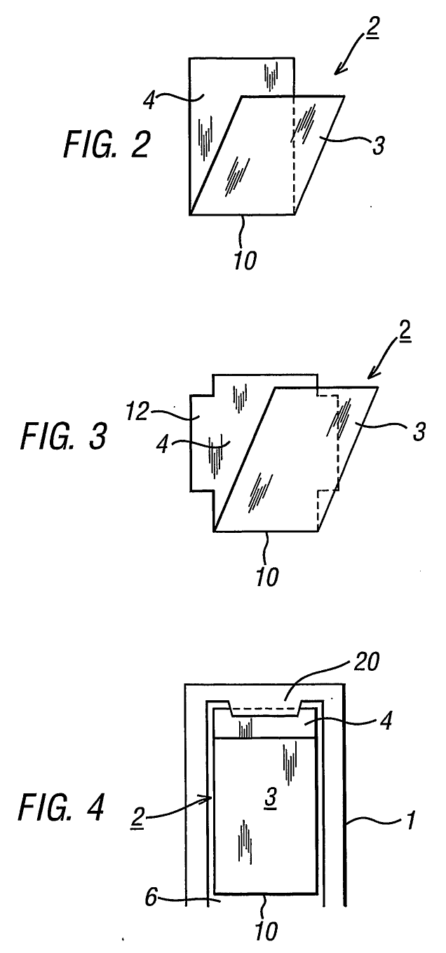

FIG. 2 shows a first example of a tab according to one aspect of the present invention;

FIG. 3 shows a second example of a tab according to one aspect of the present invention;

FIG. 4 shows an end view of a magazine for use with a first example of tab as shown in FIG. 2;

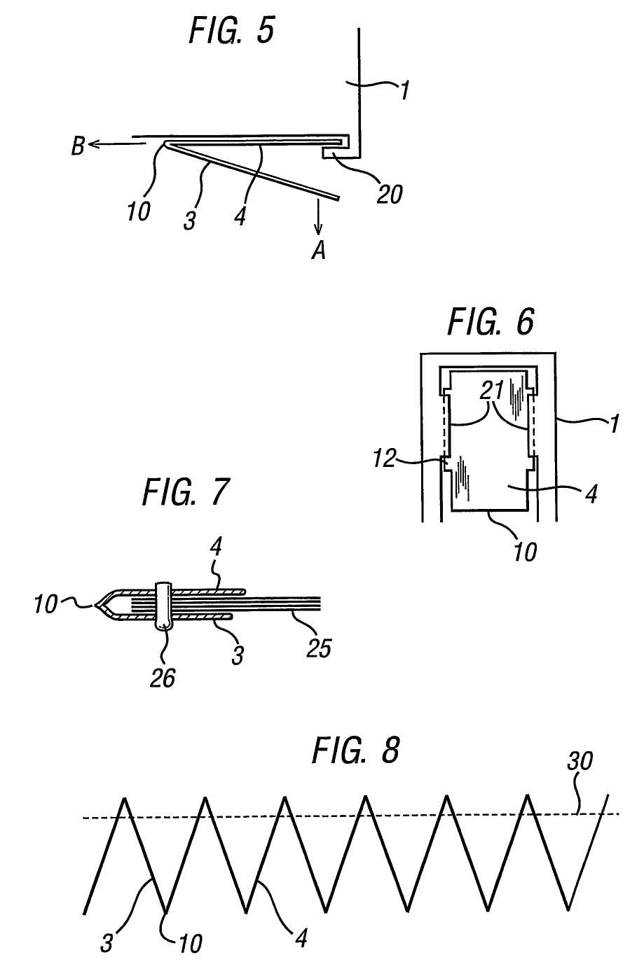

FIG. 5 shows a side view of the magazine of FIG. 4;

FIG. 6 shows an end view of a magazine for use with a second example of tab as shown in FIG. 3;

FIG. 7 shows a side view of a number of sheets of paper and a tab joined with a staple; and

FIG. 8 shows a side view of a series of tabs in a concertina.

As shown in FIG. 1, a stapler 7 includes a magazine 1 including a number of tabs 2.

A first example of a tab 2 is shown in FIG. 2. The tab 2 is formed from a strip of material, such as cardboard or a plastics material. The tab 2 includes a first portion 3 and a second portion 4. The first and second portions 3, 4 are joined by a hinge 10. The first and second portions 3, 4 are arranged non-symmetrically with respect to the hinge 10, namely the first portion 3 has a different size and/or shape to the second portion 4. In the arrangement shown in FIG. 2, the first portion 3 is shorter than the second portion 4. The tab 2 is made from a material having some resiliency, such that the free end of the first portion 3 is biased away from the free end of the second portion 4. In this way, the tab 2 has an open configuration when unsupported.

A second example of a tab 2 is shown in FIG. 3. In this case, the difference between the first portion 3 and the second portion 4 is that the second portion 4 includes extension portions 12 extending from each side of the second portion 4. This gives the second portion 4 a different size and shape to the first portion 3.

The tabs may be individually formed, for example by cutting, stamping or moulding. A preferred arrangement for forming the tabs is shown in FIG. 8. In this case, a series of tabs are formed continuously, and are then folded into a concertina or 3-fold stack. One end of the stack is then removed, for example by cutting along line 30. This separates the individual tabs.

As shown in FIG. 1, a number of tabs 2 are stacked in the magazine 1. The tabs 2 are each arranged with the first portion 3 towards an opening 6 of the magazine 1. A spring 5 or other biasing means is provided to bias the tabs 2 towards the opening 6 of the magazine 1.

The opening 6 of the magazine 1 is arranged such that the first portion 3 of the lowermost tab 2 is able to pass through the opening 6, but the second portion 4 of the tab 2 is retained within the magazine 1. FIG. 4 shows an end view of a first example of a magazine 1, intended for use with tabs 2 such as shown in FIG. 2. The opening 6 of the magazine 1 includes a projection 20. The projection 20 is arranged such that it does not contact the first portion 3 of the lowermost tab 2, but does contact the second portion 4 of the tab 2. As shown in the side view of FIG. 5, due to the resilience of the tab 2, the first portion 3, which is not retained by the projection 20, moves through the opening 6 of the magazine 1 in a first direction shown by the arrow A. However, the second portion 4 of the tab 2 is retained by the projection 20. Therefore, the tab 2 is held in place at the opening 6 of the magazine 1, with the portions 3, 4 opened away from the hinge 10. However, the tab 2 can be moved in a second direction, as shown by the arrow B into a position such as that shown in FIG. 1.

In the case of the tab 2 shown in FIG. 3, it will be appreciated that the opening 6 of the magazine 1 will have projections 21 extending from either side of the opening 6 to engage and retain the side portions 12 of the second portion 4 tab 2, as shown in the end view of FIG. 6. In this Figure, the first portion 3 of the tab 2 has been omitted for clarity.

In use, the first portion 3 of the lowermost tab 2 in the magazine 1 will be biased through the opening 6 of the magazine 1, whilst the second portion 4 of the tab 2 will be retained by the projection 20 or 21 as shown in FIG. 5. A number of sheets of paper or other items to be stapled together are then moved between the first and second portions 3, 4 of the tab 2, in a direction shown by the arrow B is FIG. 4. The edge of the items to be joined is guided along a curved or angled surface 40 of the bottom of the magazine to contact the inside of the hinge 10 of the tab 2. The continued movement of the items to be joined in direction B will move the tab 2 in the direction B, and will bring the second portion 4 of the tab 2 out of engagement with the projection 20 or 21. This action will bring the tab 2, and the edge of the items to be joined, into a stapling position shown in FIG. 1, with the first and second portions 3, 4 of the tab 2 sandwiching the items to be joined. The stapler mechanism is then actuated in the normal way, for example by pressing the handle 8, to drive a staple through the second portion 4 of the tab 2, through the items to be joined and through the first portion 3 of the tab 2. The legs of the staple are then deformed in the normal manned to lie generally along the rear of the first portion 3 of the tab 2. The resulting sandwich is shown in cross section in FIG. 7, in which sheets of paper 25 are sandwiched between the first and second portions 3, 4 of a tab 2, and are held in place by a staple 26.

To remove the staple 26, it is merely necessary to pull apart the free ends of the first and second portions 3, 4 of the tab 2. This action firstly straightens the legs of the staple 26, and then pulls the straightened legs of the staple 26 through the first portion 3 of the tab 2 and then through the sheets of paper that were held by the staple 26.

It will be appreciated that the “horizontal” stapler described with respect to the drawings, in which the items to be stapled are moved to the stapling position in a generally horizontal direction, may be replaced by a “vertical” arrangement.

Although the present invention has been described with respect to a manual stapler, it will be appreciated that the present invention is equally applicable to automated staplers, for example electric staplers. In this case, rather than a user needing to press a handle, the stapler detects the presence of items to be stapled in the stapling position, and drives a staple through the items to be joined automatically. The present invention is especially suited to such arrangements, since the items to be joined are positioned between the first and second portions of the tab, and the items are moved with the tab to the stapling position. When the items are detected at the stapling position, for example using a position sensor, the stapling mechanism drives the staple through the items and the tab.

In an alternative example, rather than joining the items using a staple, these may be joined by another fastener, such as a stitch. In this case, when the tab and the items to be joined are in the fastening position, the tab and items are sewn together with a thread driven through the tab and items using a needle. In this case, when the items are to be separated, the two portions of the tab may be pulled apart, breaking the thread and allowing this to be removed.

1. A fastening device for joining items, said fastening device comprising: a magazine holding at least one tab, said tab having a first portion with a free end, a second portion with a free end and a hinge, said first portion and said second portion being joined along said hinge such that said free ends of said first portion and said second portion are biased away from each other, said first portion having a different size and/or shape to said second portion, said magazine including an opening through which said tab is dispensed, said opening including a retainer for retaining said second portion of said tab from moving in a first direction whilst allowing said first portion of said tab to move in said first direction, said tab being removable from said magazine in a second direction generally perpendicular to said first direction to a fastening position, and a fastening mechanism for driving a fastener to join said tab and said items to be joined.

2. A fastening device according to claim 1, in which said fastener is a staple.

3. A fastening device according to claim 1, in which said fastener is in the form of a stitch.

4. A fastening device according to claim 1, in which a mechanism is provided for selectively preventing said first portion of said tab from passing though said opening of said magazine.

5. A fastening device according to claim 4, in which said mechanism for selectively preventing said first portion of said tab from passing through said opening of said magazine comprises a mechanical means such as a manually actuated sliding member or an electronic push button to close said first opening in said magazine.

6. A fastening device according to claim 4, in which, said magazine may be removed from said fastening device when said tab is not required.

7. A magazine suitable for use in a fastening device according to claim 1, said magazine being arranged to hold at least one tab, said tab having a first portion with a free end, a second portion with a free end, and a hinge, said first portion and said second portion being joined along said hinge such that said free ends of said first portion and said second portion are biased away from each other, said first portion of said tab having a different size and/or shape to said second portion, said magazine includes an opening through which said tab is dispensed, said opening including a retainer for retaining said second portion of said tab from moving in a first direction whilst allowing said first portion of said tab to move in the first direction, said tab being removable from said magazine in a second direction generally perpendicular to said first direction.

8. A magazine according to claim 7, in which said retainer is in the form of one or more projections or lips that extend into said opening of said magazine for retaining said second portion of said tab.

9. A magazine according to claim 8, in which said projection or lip is arranged in a position such that, when said first portion and said second portion of said tab are adjacent each other, said projection or lip extends over an area of said second portion of said tab not covered by said first portion.

10. A magazine according to claim 7, in which said tabs contained in said magazine are biased towards said opening of said magazine.

11. A magazine according to claim 10, including a resilient biasing means, such as a spring, to bias tabs towards said opening of said magazine.

12. A magazine according to claim 11, in which said biasing means is a coil spring.

13. A magazine according to claim 7, formed from a plastic or metal material.

14. A magazine according to claim 7, including an openable or removable side through which said tabs may be inserted.

15. A magazine according to claim 7, formed of a transparent material.

16. A fastening device according to claim 1, including a magazine in accordance with claim 7.

17. A tab for use with a fastener device, the tab comprising: a first portion with a free end, a second portion with a free end, and a hinge, said first portion and said second portion being joined along said hinge such that said free ends of said first portion and said second portion are biased away from each other, said first portion having a different size and/or shape to said second portion such that said second portion of said tab can be retained from moving in a first direction whilst allowing said second portion of said tab to move in said first direction, said tab being removable from a magazine in a second direction generally perpendicular to said first direction.

18. A tab according to claim 17, in which said first portion of said tab is shorter than said second portion of said tab.

19. A tab according to claim 17, in which said first portion of said tab has a smaller width than said second portion of said tab.

20. A tab according to claim 17, in which said hinge of said tab is a fold between said first portion and said second portion of said tab.

21. A tab according to claim 17, in which said tab is formed from a plastics material.

22. A tab according to claim 21, in which said tab is formed from polypropylene.

23. A tab according to claim 17, in which said tab is stamped or cut from a sheet of material.

24. A tab according to claim 17, having a thickness of between about 0.1 mm and 0.75 mm, and preferably of about 0.25 mm.

25. A plurality of tabs according to claim 17, said tabs being provided with printed matter so as to form labels.

26. A plurality of tabs according to claim 17, said tabs being releasably fastened together so that they may be handled conveniently as a single unit.

27. A plurality of tabs according to claim 26, in which the plurality of tabs are held together by an encircling band.

28. A magazine according to claim 7, including a plurality of tabs according to claim 17.

29. A magazine according to claim 28, said magazine having an internal structure shaped to correspond to said tabs, and thereby maintain said tabs in alignment.

30. A fastening device according to claim 1, including a tab in accordance with claim 17.

31. A method of joining items comprising: providing a tab having a first portion with a free end, a second portion with a free end, and a hinge, said first portion and said second portion being joined along said hinge such that said free ends of said first portion and said second portion are biased away from each other, said first portion having a different size and/or shape to said second portion, restraining said second portion of said tab from moving in a first direction whilst allowing said first portion of said tab to move in said first direction, providing a number of items to be stapled between said free ends of said first portion and said second portion of said tab, and moving said items in a second direction generally perpendicular to said first direction to abut against the join between said first portion and said second portion of said tab, and continuing the movement of said items to be joined to remove said tab in a second direction generally perpendicular to said first direction, and passing a fastener through said first portion and said second portion of said tab sandwiching said items to be joined.

32. A method according to claim 31, in which said tabs are formed in accordance with claim 17.

33. (canceled)

34. (canceled)

35. (canceled)

36. (canceled)
